(19) United States
(12) Patent Application Publication
(10) Pub. No.: US 2024/0333519 A1
(43) Pub. Date: Oct. 3, 2024

(54) SYSTEMS AND METHODS FOR IMPROVING RESOURCE UTILIZATION AND SYSTEM PERFORMANCE IN END-TO-END ENCRYPTION

(71) Applicant: Advanced Micro Devices, Inc., Santa Clara, CA (US)

(72) Inventors: SeyedMohammad SeyedzadehDelcheh, Bellevue, WA (US); Sergey Blagodurov, Bellevue, WA (US); Donald Matthews, Jr., Fort Collins, CO (US); Srilatha Manne, Bellevue, WA (US)

(73) Assignee: Advanced Micro Devices, Inc., Santa Clara, CA (US)

(21) Appl. No.: 18/194,394

(22) Filed: Mar. 31, 2023

(51) Int. Cl. H04L 9/32

(52) U.S. Cl. CPC H04L 9/3242

(57) ABSTRACT

The disclosed computing device can include super flow control unit (flit) generation circuitry configured to generate a super flit containing two or more flits having two or more requests embedded therein, wherein the two or more requests have the same destination node identifiers and the super flit has a variable size based on a flit size and a number of existing requests in a source node that target a same destination node. The device can additionally include authentication circuitry configured to append a message authentication code to a last flit of the super flit. The device can also include communication circuitry configured to send the super flit to a network switch configured to route the super flit to a destination node corresponding to the same destination node identifiers. Various other methods, systems, and computer-readable media are also disclosed.

### BACKGROUND

In computer networking, a flit (FLow control unIT) is a link-level atomic piece that forms a network packet or stream. End-to-end encryption encrypts flits that target the same destination node and forwards them to a network switch that is in an untrusted domain. Then, the flits in the network are directed toward the destination node through intermediate network hops by a specific flit forward mechanism. Finally, the destination node decrypts and verifies received flits via a Message Authentication Code (MAC).

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram of an example system for improving resource utilization and system performance in end-to-end encryption.

FIG. 2 is a block diagram of an additional example system for improving resource utilization and system performance in end-to-end encryption.

FIG. 3 is a flow diagram of an example method for improving resource utilization and system performance in end-to-end encryption.

FIG. 4 is a block diagram illustrating load and store operations in end-to-end encryption.

FIG. 5 is a graphical illustration depicting 256 B flit occupancy when flits are sent from a compute node (CNode) to a fabric attached memory node (FAMNode).

FIG. 6 is a graphical illustration depicting 256 B flit occupancy when flits are sent from a FAMNode to a CNode.

FIG. 7 is a flow diagram illustrating variable size super flits in end-to-end encryption.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for improving resource utilization and system performance in end-to-end encryption. End-to-end encryption results in low flit utilization when a fixed flit size is used to pack requests. There are two main reasons for this issue. For example, few requests target the same destination node when there are many destination nodes. Also, requests have different sizes; thus, they do not become a fit to the single flit.

The above issues are described herein with reference to a 256 B flit size (e.g., the standard flit size used in Compute Express Link (CXL) version 3.0), but other fixed flit sizes can result in the same issues. An observation from analyzing 256 bytes flit occupancy of various workloads is that some workloads require small flit size (e.g., 64B) to achieve highest flit utilization, while other workloads take advantage of large flit size to maximize flit utilization and improve system bandwidth. This observation highlights the advantages stemming from utilizing the disclosed variable size super flit in end-to-end encryption whose granularity ranges from a L-bytes flit to N L-bytes flits, where N depends on the number of existing requests in the source node that targets the destination node.

Unfortunately, in end-to-end encryption, appending the MAC of the super flit to the first flit of a next super flit is not a practical solution when there are thousands of destination points because all received super flits must be buffered until the first flit of the next super flit has arrived and an integrity check passes, thereby incurring high area overhead in the destination node.

To this end, the disclosed techniques implement a variable size super flit-based mechanism in end-to-end encryption to append the MAC to the last flit of the current super flit, thereby improving flit utilization and network bandwidth. Specifically, the proposed mechanism in the source node extracts requests with the same destination node identifiers (IDs) from a request list. The mechanism can select R requests (e.g., consecutive requests) whose total size is smaller than (N*L−M) bytes, where N is the number of flits in the super flit, L is the flit size, and M is the MAC size. In some implementations, the proposed mechanism can generate the MAC from requests that target the same destination node, encrypt requests (e.g., utilizing a counter mode encryption engine), embed requests in N flits, append M-bytes MAC to the last flit of the super flit, and send flits to a network switch. When the destination node receives N flits, it can decrypt flits to regenerate the MAC. Finally, it can extract the MAC from a last flit of the current super flit and compare it with the regenerated MAC to verify the original (e.g., decrypted) requests. The proposed mechanism improves system bandwidth and performance compared to the existing solution in CXL 3.0, while avoiding sacrifice of area overhead.

In one example, a computing device includes super flow control unit (flit) generation circuitry configured to generate a super flit containing two or more flits having two or more requests embedded therein, wherein the two or more requests have destination node identifiers that are the same and the super flit has a variable size based on a flit size and a number of existing requests in a source node that target a same destination node, authentication circuitry configured to append a message authentication code to a last flit of the super flit, and communication circuitry configured to send the super flit to a network switch configured to route the super flit to a destination node corresponding to the same destination node identifiers.

Another example can be the previously described computing device, wherein the super flit generation circuitry is configured to generate the super flit at least in part by extracting requests that have the same destination node identifiers, selecting, from the extracted requests, the two or more requests, wherein the two or more requests have a total size less than N*L−M bytes, where N is a number of flits in the super flit, L is the flit size, and M is a message authentication code size, encrypting the two or more requests, and embedding the encrypted two or more requests in N flits of the super flit.

Another example can be the computing device of any of the previously described computing devices, wherein the super flit generation circuitry is configured to extract the requests from a request list.

Another example can be the computing device of any of the previously described computing devices, wherein the super flit generation circuitry is configured to encrypt the two or more requests utilizing a counter mode encryption engine.

Another example can be the computing device of any of the previously described computing devices, wherein the authentication circuitry is further configured to generate the message authentication code based on the two or more requests.

Another example can be the computing device of any of the previously described computing devices, wherein the network switch corresponds to a network switch of a switch fabric.

Another example can be the computing device of any of the previously described computing devices, wherein the destination node is configured to receive the two or more flits of the super flit, decrypt the two or more requests embedded in the received two or more flits, regenerate the message authentication code based on the decrypted two or more requests, extract the message authentication code appended to the last flit of the super flit, compare the extracted message authentication code and the regenerated message authentication code, and verify the decrypted two or more requests based on a result of the comparison.

In one example, a system can include at least one physical processor and physical memory comprising computer-executable instructions that, when executed by the at least one physical processor, cause the at least one physical processor to generate a super flit containing two or more flits having two or more requests embedded therein, wherein the two or more requests have destination node identifiers that are the same and the super flit has a variable size based on a flit size and a number of existing requests in a source node that target a same destination node, append a message authentication code to a last flit of the super flit, and send the super flit to a network switch configured to route the super flit to a destination node corresponding to the same destination node identifiers.

Another example can be the system of the previously described example system, wherein the instructions cause the at least one physical processor to generate the super flit at least in part by extracting requests that have the same destination node identifiers, selecting, from the extracted requests, the two or more requests, wherein the two or more requests have a total size less than N*L−M bytes, where N is a number of flits in the super flit, L is the flit size, and M is a message authentication code size, encrypting the two or more requests, and embedding the encrypted two or more requests in N flits of the super flit.

Another example can be the system of any of the previously described example systems, wherein the instructions cause the at least one physical processor to extract the requests from a request list.

Another example can be the system of any of the previously described example systems, wherein the instructions cause the at least one physical processor to encrypt the two or more requests utilizing a counter mode encryption engine.

Another example can be the system of any of the previously described example systems, wherein the instructions cause the at least one physical processor to generate the message authentication code based on the two or more requests.

Another example can be the system of any of the previously described example systems, wherein the network switch corresponds to a network switch of a switch fabric.

Another example can be the system of any of the previously described example systems, wherein the destination node is configured to receive the two or more flits of the super flit, decrypt the two or more requests embedded in the received two or more flits, regenerate the message authentication code based on the decrypted two or more requests, extract the message authentication code appended to the last flit of the super flit, compare the extracted message authentication code and the regenerated message authentication code, and verify the decrypted two or more requests based on a result of the comparison.

In one example, a computer-implemented method can include generating, by at least one processor, a super flit containing two or more flits having two or more requests embedded therein, wherein the two or more requests have destination node identifiers that are the same and the super flit has a variable size based on a flit size and a number of existing requests in a source node that target a same destination node, appending, by the at least one processor, a message authentication code to a last flit of the super flit, and sending, by the at least one processor, the super flit to a network switch configured to route the super flit to a destination node corresponding to the same destination node identifiers.

Another example can be the method of the previously described example method, wherein generating the super flit includes extracting requests that have the same destination node identifiers, selecting, from the extracted requests, the two or more requests, wherein the two or more requests have a total size less than N*L−M bytes, where N is a number of flits in the super flit, L is the flit size, and M is a message authentication code size, encrypting the two or more requests, and embedding the encrypted two or more requests in N flits of the super flit.

Another example can be the method of any of the previously described example methods, wherein the requests are extracted from a request list.

Another example can be the method of any or the previously described example methods, wherein the two or more requests are encrypted utilizing a counter mode encryption engine.

Another example can be the method of any of the previously described example methods, further comprising generating the message authentication code based on the two or more requests.

Another example can be the method of any or the previously described example methods, wherein the network switch corresponds to a network switch of a switch fabric.

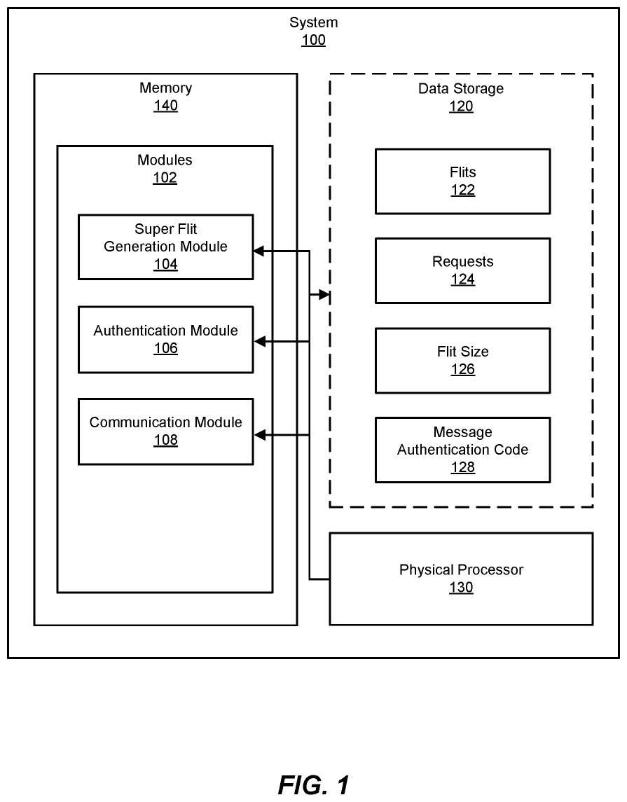

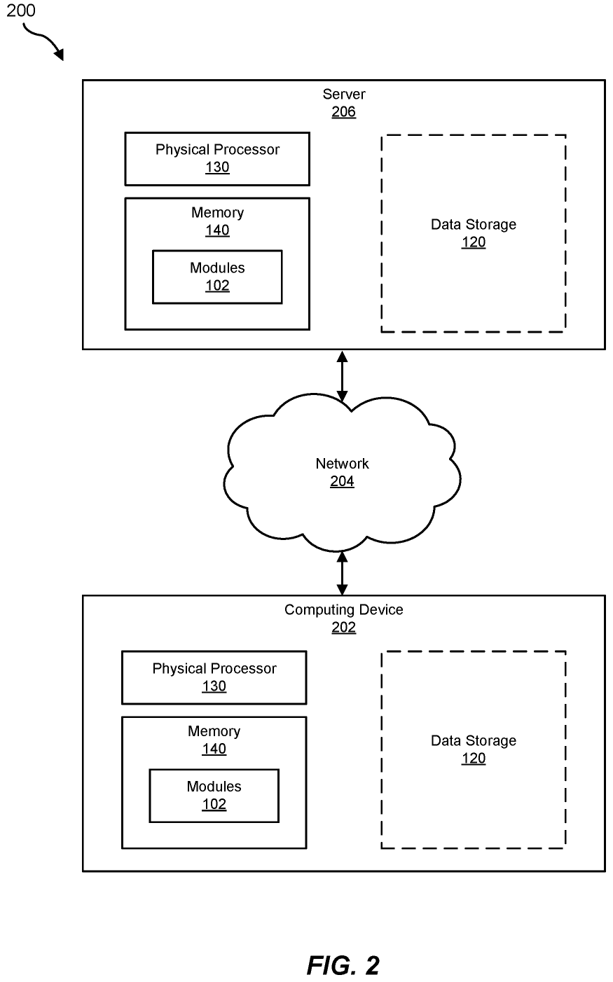

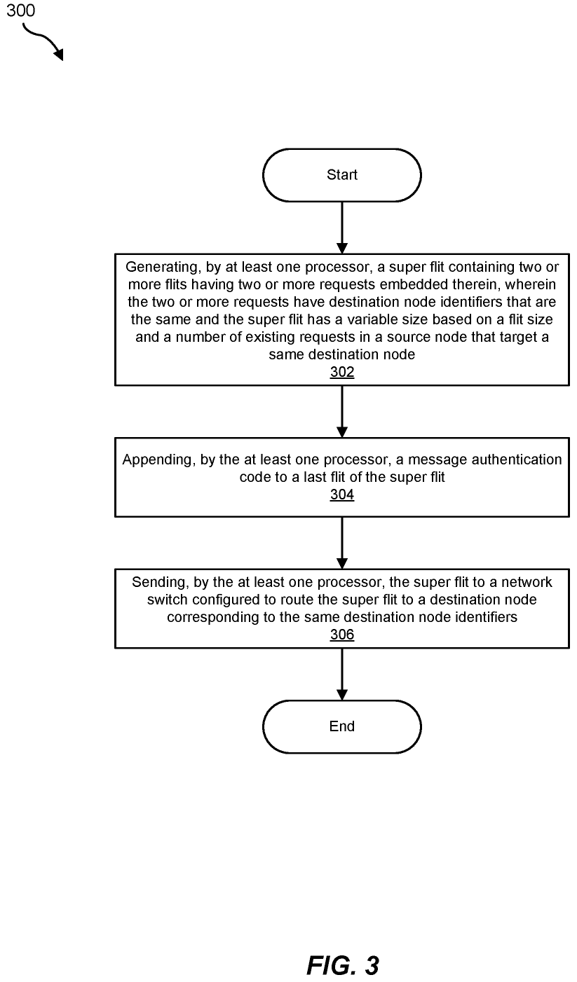

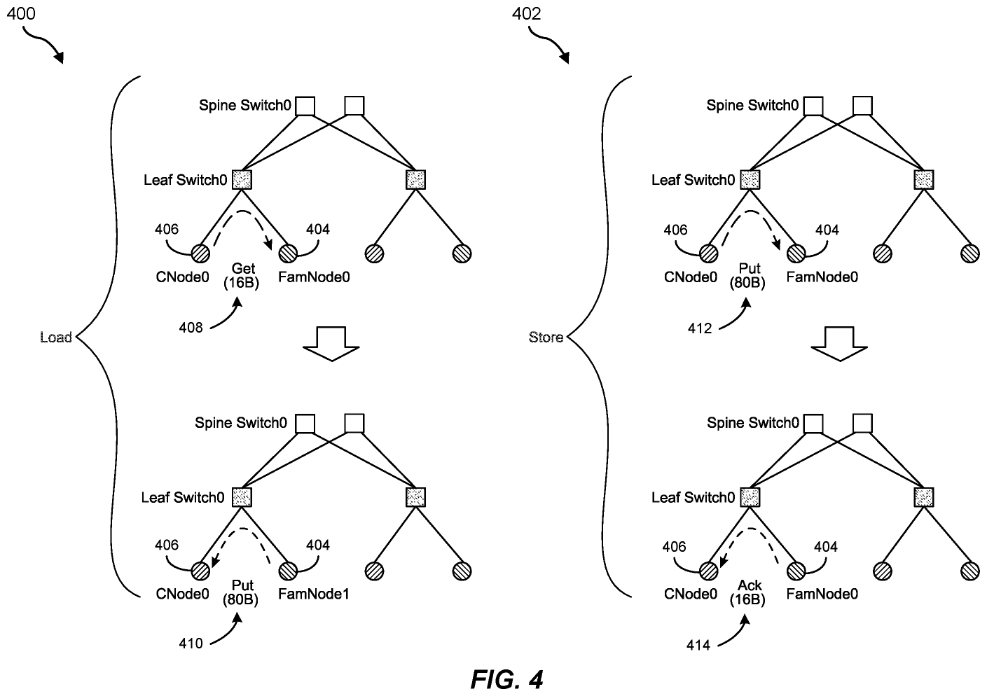

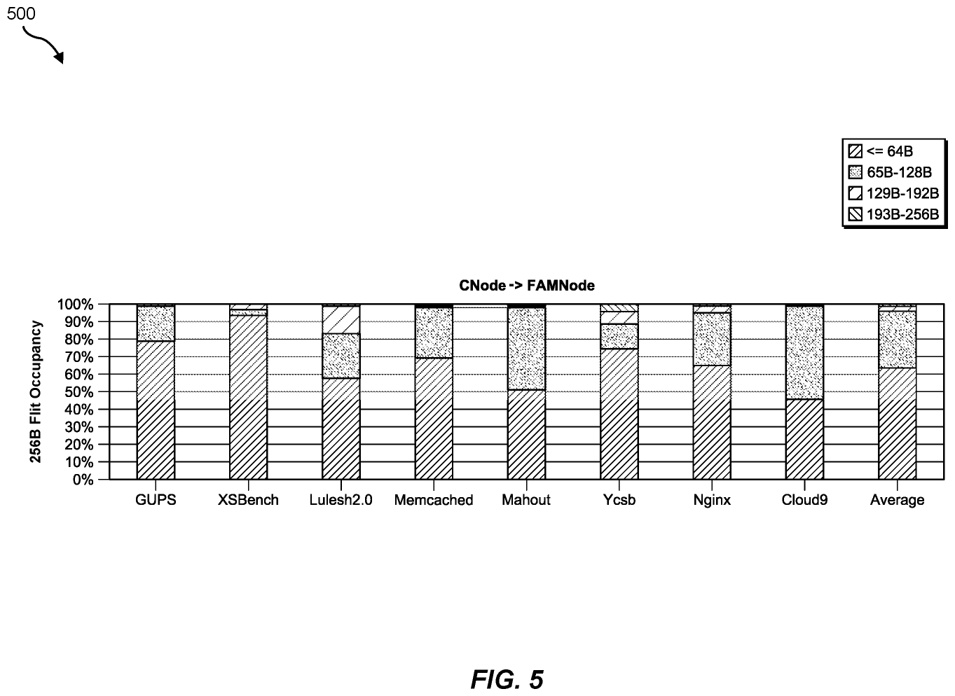

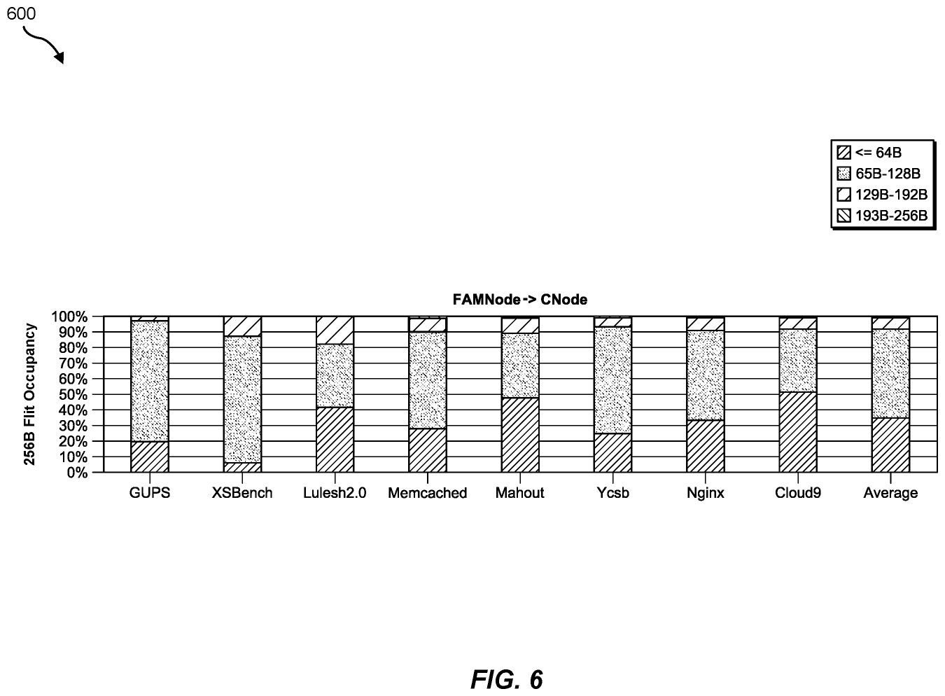

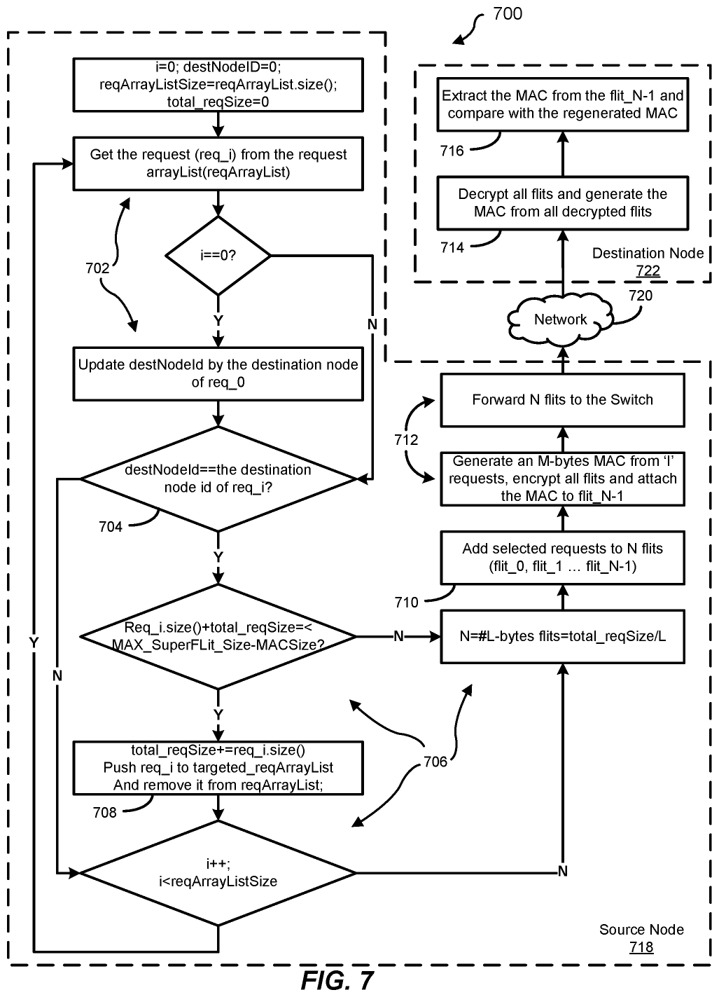

The following will provide, with reference to FIGS. 1-2, detailed descriptions of example systems for improving resource utilization and system performance in end-to-end encryption. Detailed descriptions of corresponding computer-implemented methods will also be provided in connection with FIG. 3. In addition, detailed descriptions of example load and store operations in end-to-end encryption will be provided with reference to FIG. 4. Further, detailed descriptions of 256 B occupancy when flits are exchanged between nodes will be provided with reference to FIGS. 5 and 6. Further, detailed descriptions of variable size super flits in end-to-end encryption will be provided with reference to FIG. 7.

FIG. 1 is a block diagram of an example system 100 for improving resource utilization and system performance in end-to-end encryption. As illustrated in this figure, example system 100 can include one or more modules 102 for performing one or more tasks. As will be explained in greater detail below, modules 102 can include a super flit generation module 104, an authentication module 106, and a communication module 108. Although illustrated as separate elements, one or more of modules 102 in FIG. 1 can represent portions of a single module or application.

In certain implementations, one or more of modules 102 in FIG. 1 can represent one or more software applications or programs that, when executed by a computing device, can cause the computing device to perform one or more tasks. For example, and as will be described in greater detail below, one or more of modules 102 can represent modules stored and configured to run on one or more computing devices, such as the devices illustrated in FIG. 2 (e.g., computing device 202 and/or server 206). One or more of modules 102 in FIG. 1 can also represent all or portions of one or more special-purpose computers configured to perform one or more tasks.

As illustrated in FIG. 1, example system 100 can also include one or more memory devices, such as memory 140. Memory 140 generally represents any type or form of volatile or non-volatile storage device or medium capable of storing data and/or computer-readable instructions. In one example, memory 140 can store, load, and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As illustrated in FIG. 1, example system 100 can also include one or more physical processors, such as physical processor 130. Physical processor 130 generally represents any type or form of hardware-implemented processing unit capable of interpreting and/or executing computer-readable instructions. In one example, physical processor 130 can access and/or modify one or more of modules 102 stored in memory 140. Additionally or alternatively, physical processor 130 can execute one or more of modules 102 to facilitate improving resource utilization and system performance in end-to-end encryption. Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As illustrated in FIG. 1, example system 100 can also include one or more instances of stored data, such as data storage 120. Data storage 120 generally represents any type or form of stored data, however stored (e.g., signal line transmissions, bit registers, flip flops, software in rewritable memory, configurable hardware states, combinations thereof, etc.). In one example, data storage 120 includes databases, spreadsheets, tables, lists, matrices, trees, or any other type of data structure. Examples of data storage 120 include, without limitation, flits 122, requests 124, flit size 126, and message authentication code 128.

Example system 100 in FIG. 1 can be implemented in a variety of ways. For example, all or a portion of example system 100 can represent portions of example system 200 in FIG. 2. As shown in FIG. 2, system 200 can include a computing device 202 in communication with a server 206 via a network 204. In one example, all or a portion of the functionality of modules 102 can be performed by computing device 202, server 206, and/or any other suitable computing system. As will be described in greater detail below, one or more of modules 102 from FIG. 1 can, when executed by at least one processor of computing device 202 and/or server 206, enable computing device 202 and/or server 206 to improve resource utilization and system performance in end-to-end encryption.

Computing device 202 generally represents any type or form of computing device capable of reading computer-executable instructions. In some implementations, computing device 202 can be and/or include a graphics processing unit having a chiplet processor connected by a switch fabric. Additional examples of computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device.

Server 206 generally represents any type or form of computing device that is capable of reading computer-executable instructions. In some implementations, computing device 202 can be and/or include a cloud service (e.g., cloud gaming server) that includes a graphics processing unit having a chiplet processor connected by a switch fabric. Additional examples of server 206 include, without limitation, storage servers, database servers, application servers, and/or web servers configured to run certain software applications and/or provide various storage, database, and/or web services. Although illustrated as a single entity in FIG. 2, server 206 can include and/or represent a plurality of servers that work and/or operate in conjunction with one another.

Network 204 generally represents any medium or architecture capable of facilitating communication or data transfer. In one example, network 204 can facilitate communication between computing device 202 and server 206. In this example, network 204 can facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to system 100 in FIG. 1 and/or system 200 in FIG. 2. Conversely, all of the components and devices illustrated in FIGS. 1 and 2 need not be present to practice the implementations described and/or illustrated herein. The devices and subsystems referenced above can also be interconnected in different ways from that shown in FIG. 2. Systems 100 and 200 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIG. 3 is a flow diagram of an example computer-implemented method 300 for improving resource utilization and system performance in end-to-end encryption. The steps shown in FIG. 3 can be performed by any suitable computer-executable code and/or computing system, including system 100 in FIG. 1, system 200 in FIG. 2, and/or variations or combinations of one or more of the same. In one example, each of the steps shown in FIG. 3 can represent an algorithm whose structure includes and/or is represented by multiple sub-steps, examples of which will be provided in greater detail below.

As illustrated in FIG. 3, at step 302 one or more of the systems described herein can generate a super flit. For example, super flit generation module 104 can, as part of computing device 202 in FIG. 2, generate, by at least one processor, a super flit containing two or more flits having two or more requests embedded therein, wherein the two or more requests have destination node identifiers that are the same and the super flit has a variable size based on a flit size and a number of existing requests in a source node that target a same destination node.

The term “flit,” as used herein, can generally refer to routing information for transmitted data. For example, and without limitation, a flit can be a flit (flow control unit or flow control digit) that is a link-level atomic piece that forms a network packet or stream. Example types of flits include, without limitation, a first flit, called the header flit, that holds information about a packet's route (e.g., a destination address) and sets up routing behavior for all subsequent flits associated with a packet. The header flit can be followed by zero or more body flits, containing the actual payload of data. A final flit, called a tail flit, can perform some book keeping to close a connection between the two nodes. In this context, the term “super flit,” as used herein, can generally refer to a message that includes more than one flit.

The term “request,” as used herein, can generally refer to a method to indicate a desired action to be performed on an identified resource. For example, and without limitation, types of requests can include get requests and put requests. In some examples, a get request can be used to read or retrieve a resource, and a successful “get” can return a response containing the information requested. Additionally or alternatively, a put request can be used to modify a resource. For example, the requested “put” can update an entire resource with data that is passed in a body payload. If there is no resource that matches the request, the “put” can create a new resource.

The term “consecutive requests,” as used herein, can generally refer to requests that follow one after the other, in order, in a request list at a source node. For example, and without limitation, consecutive requests can be get requests and/or put requests that are listed in sequence in the request list (e.g., request queue) at the source node. In this context, two or more consecutive requests that have destination node identifiers that are the same can include all of the consecutive requests (e.g., up to a determined size) in the request list that target (e.g., addressed to, designated to be sent to) a same destination node.

The term “node,” as used herein, can generally refer to a redistribution point or a communication endpoint in a communications network. Example types of nodes can include, without limitation, a source node and a destination node. In this context, the source node can transmit data over the communications network to the destination node. Further in this context, a “destination node identifier” can be a network address and/or other information that causes the communications network to route the data to the destination node.

The systems described herein can perform step 302 in a variety of ways. In some examples, super flit generation module 104, as part of computing device 202 in FIG. 2, can extract (e.g., from a request list) requests that have the same destination node identifiers. For example, super flit generation module 104, as part of computing device 202 in FIG. 2, can read data of the requests from a computer readable medium storing the request list. In some of these examples, super flit generation module 104, as part of computing device 202 in FIG. 2, can select, from the extracted requests, two or more consecutive requests, wherein the two or more consecutive requests have a total size less than N*L−M bytes, where N is a number of flits in the super flit, L is the flit size, and M is a message authentication code size. In some of these examples, super flit generation module 104, as part of computing device 202 in FIG. 2, can encrypt (e.g., utilizing a counter mode encryption engine) the two or more consecutive requests. In some of these examples, super flit generation module 104, as part of computing device 202 in FIG. 2, can embed the encrypted two or more consecutive requests in N flits of the super flit. For example, super flit generation module 104, as part of computing device 202 in FIG. 2, can store data of the selected, extracted, and encrypted requests in a computer-readable medium, such as a transmit buffer or another memory location.

At step 304, one or more of the systems described herein can append a message authentication code. For example, authentication module 106 can, as part of computing device 202 in FIG. 2, append, by the at least one processor, a message authentication code to a last flit of the super flit.

The term “message authentication code,” as used herein, can generally refer to a short piece of information used for authenticating a message. In other words, the message authentication code can be used to confirm that the message came from a stated sender (i.e., its authenticity) and has not been changed. A message authentication code value can protect a message's data integrity, as well as its authenticity, by allowing verifiers (e.g., who may also possess a secret key) to detect any changes to the message content.

The systems described herein can perform step 304 in a variety of ways. For example, authentication module 106, as part of computing device 202 in FIG. 2, can store data of the message authentication code in the computer-readable medium (e.g., transmit buffer or other memory location) in a location adjacent to a location in which the data of the requests is stored. In some examples, authentication module 106, as part of computing device 202 in FIG. 2, can generate the message authentication code based on the two or more consecutive requests.

At step 306, one or more of the systems described herein can send the super flit. For example, communication module 108 can, as part of computing device 202 in FIG. 2, send, by the at least one processor, the super flit to a network switch configured to route the super flit to a destination node corresponding to the same destination node identifiers.

The term “network switch,” as used herein, can generally refer to networking hardware that connects devices on a computer network by using packet switching to receive and forward data to a destination device. For example, and without limitation, types of network switches can include a switching hub, a bridging hub, and a MAC bridge.

The systems described herein can perform step 306 in a variety of ways. In some examples, communication module 108, as part of computing device 202 in FIG. 2, can send the super flit to a network switch of a switch fabric. For example, communication module 108, as part of computing device 202 in FIG. 2, can transmit data stored in the transmit buffer over the switch fabric to the network switch. In some of these examples, communication module 108, as part of computing device 202 in FIG. 2, can load the data stored in the other memory location into the transmit buffer before transmitting the data stored in the transmit buffer over the switch fabric to the network switch. In some examples, the destination node can be configured to receive the two or more flits of the super flit, decrypt two or more consecutive requests embedded in the received two or more flits and regenerate the message authentication code based on the decrypted two or more consecutive requests. In some of these examples, the destination node can extract the message authentication code appended to the last flit of the super flit, compare the extracted message authentication code and the regenerated message authentication code, and verify the decrypted two or more consecutive requests based on a result of the comparison.

FIGS. 4-6 demonstrate that the disclosed techniques evidence numerous advantages by avoiding various issues arising with utilization of a fixed flit size (e.g., a limited number of predetermined flit sizes as supported in CXL 3.0). The latest version of CXL 3.0 supports two different flit sizes (i.e., 68B and 256 B) and appends the MAC to the first flit of a next super flit that incurs high area overhead. For example, if the super flit consists of N 256 B flits and the number of end points is 2000, each destination node needs to have at least 2K*N*256 B=0.5*N*MB storage to store super flits until the flit of the next super flit has arrived and an integrity check passes.

FIG. 4 depicts an analysis performed by setting a flit size to 256 B and analyzing the flit occupancy of end-to-end encryption across various applications. Load operation 400 and store operation 402 are shown. Assumptions used in this analysis include loading a 64B cache line from a Fabric-Attached Memory (FAM) node 404 and issuance by a Compute Node (CNode) 406 of a 16B Get request 408. When the FAMNode 404 receives the Get request 408 during the load operation 400, it can issue a Put request 410 that includes 64B cache line data and a 16B header (i.e., totaling 80B). For the store operation 402, the CNode 406 can issue the Put request 412. When the FAMNode 404 receives the Put request 412, it can issue a 16B Ack request 414 to inform the corresponding CNode 406 that the Put request 412 is received.

Referring to FIG. 5, graph 500 demonstrates that when the requests are sent from the CNode to the FAMNode, many flits across different applications experience less than 64B occupancy. This low occupancy is due to the small number of requests that target the same destination node in end-to-end encryption. Referring to FIG. 6, graph 600 demonstrates that when FAMNodes return the payloads to the CNode, many flits experience 65B-128B occupancy, resulting in approximately 50% wasted bandwidth. This wasted system bandwidth is a result of utilizing a fixed flit size (e.g., 256 B) for end-to-end encryption. To increase the flit utilization for end-to-end encryption, a variable size super flit may be utilized that has a granularity ranging from an L-bytes flit to an N L-bytes flits, where N depends on the number of existing requests in the source node that targets the destination node.

To verify flits in the destination node, CXL 3.0 generates a message authentication code for the super flit and appends it to the flit of a next super flit that targets the same destination node. However, this authentication technique requires that the received super flit be buffered until the first flit of a next super flit arrives and an integrity check passes. Accordingly, this authentication technique is not a practical solution for end-to-end encryption when there are thousands of destination points because the required buffering incurs high area overhead in the destination node.

Referring to FIG. 7, an example method 700 implementing the disclosed techniques can utilize a super flit whose size ranges from a minimum existing flit size (L-bytes) (e.g., in CXL) to N L-bytes flits, where N is determined by the total size of existing requests in the source node. Moreover, a message authentication code (e.g., 16B MAC) can be appended to the last flit of the same super flit in end-to-end encryption.

In an example implementation, method 700 can operate according to steps 702-716. For example, a source node 718 can, at step 702, get a first request, called ‘req_0,’ from a request array list and record its destination node identifier. Additionally, the source node 718 can, at step 704, search in the request list to find all requests that have the same destination identifier as the first request. Also, the source node can, at step 706, stop the search process when either ‘total_reqSize>(MAX_SuperFlit_Size-MACSize’) or it reaches an end of the request array list, at which point the source node can determine a maximum super flit size supported by a network switch (e.g., CXL switch). Alternatively, if neither of the conditions tested in step 706 is satisfied, the source node 718 can, at step 708, add a size of the requests to a temporary variable (e.g., called ‘total_reqSize’) and add the request (e.g., called ‘req_i’) to a temporary array list (e.g., called ‘targeted_reqArrayList’). From step 708, processing at the source node 718 can return to step 702 and continue until one of the conditions tested at step 706 is satisfied, at which point the source node 718 can, at step 710, add all selected requests to N L-bytes flits (flit_0, flit_1 . . . . Flit_N−1), where ‘N’ can be determined as ‘total_reqSize’ divided by the size of the flit ‘L’. Next, source node 718 can, at step 712, generate a message authentication code (e.g., 16B MAC) from all of the selected requests and append the message authentication code to the end of the flit_N−1, encrypt all N flits, and send all of the encrypted flits of the super flit to a network 720 (e.g., switch fabric). In turn, destination node 722 can, at step 712, receive the N flits, decrypt the N flits, and regenerate the message authentication code from the decrypted N flits. Finally, the destination node 722 can, at step 714, extract the message authentication code from ‘flit_N−1’ and compare it with the regenerated MAC to verify all of the received N flits.

As set forth above, the disclosed systems and methods utilize a variable-size super flit in end-to-end encryption that has a granularity ranging from a minimum configured flit size up to multiple flits of that size that are together sufficient to embed all existing requests in a source node that target a same destination node (e.g., up to a maximum configured flit size). Additionally, the disclosed systems and methods append a message authentication code to a last flit of the current super flit, thereby improving flit utilization and network bandwidth. Advantageously, the disclosed systems and methods improve system bandwidth and performance (e.g., compared to the existing solution in CXL 3.0) without sacrificing area overhead.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device, comprising:
super flow control unit (flit) generation circuitry configured to generate a super flit containing two or more flits having two or more requests embedded therein, wherein the two or more requests have destination node identifiers that are the same and the super flit has a variable size based on a flit size and a number of existing requests in a source node that target a same destination node;
authentication circuitry configured to append a message authentication code to a last flit of the super flit; and
communication circuitry configured to send the super flit to a network switch configured to route the super flit to a destination node corresponding to the same destination node identifiers.

2. The computing device of claim 1, wherein the super flit generation circuitry is configured to generate the super flit at least in part by:
extracting requests that have the same destination node identifiers;
selecting, from the extracted requests, the two or more requests, wherein the two or more requests have a total size less than N*L−M bytes, where N is a number of flits in the super flit, L is the flit size, and M is a message authentication code size;
encrypting the two or more requests; and
embedding the encrypted two or more requests in N flits of the super flit.

3. The computing device of claim 2, wherein the super flit generation circuitry is configured to extract the requests from a request list.

4. The computing device of claim 2, wherein the super flit generation circuitry is configured to encrypt the two or more requests utilizing a counter mode encryption engine.

5. The computing device of claim 1, wherein the authentication circuitry is further configured to generate the message authentication code based on the two or more requests.

6. The computing device of claim 1, wherein the network switch corresponds to a network switch of a switch fabric.

7. The computing device of claim 1, wherein the destination node is configured to:
receive the two or more flits of the super flit;
decrypt the two or more requests embedded in the received two or more flits;
regenerate the message authentication code based on the decrypted two or more requests;
extract the message authentication code appended to the last flit of the super flit;
compare the extracted message authentication code and the regenerated message authentication code; and
verify the decrypted two or more requests based on a result of the comparison.

8. A system comprising:
at least one physical processor; and
physical memory comprising computer-executable instructions that, when executed by the at least one physical processor, cause the at least one physical processor to:
generate a super flit containing two or more flits having two or more requests embedded therein, wherein the two or more requests have destination node identifiers that are the same and the super flit has a variable size based on a flit size and a number of existing requests in a source node that target a same destination node;
append a message authentication code to a last flit of the super flit; and
send the super flit to a network switch configured to route the super flit to a destination node corresponding to the same destination node identifiers.

9. The system of claim 8, wherein the instructions cause the at least one physical processor to generate the super flit at least in part by:
extracting requests that have the same destination node identifiers;
selecting, from the extracted requests, the two or more requests, wherein the two or more requests have a total size less than N*L−M bytes, where N is a number of flits in the super flit, L is the flit size, and M is a message authentication code size;
encrypting the two or more requests; and
embedding the encrypted two or more requests in N flits of the super flit.

10. The system of claim 9, wherein the instructions cause the at least one physical processor to extract the requests from a request list.

11. The system of claim 9, wherein the instructions cause the at least one physical processor to encrypt the two or more requests utilizing a counter mode encryption engine.

12. The system of claim 8, wherein the instructions cause the at least one physical processor to generate the message authentication code based on the two or more requests.

13. The system of claim 8, wherein the network switch corresponds to a network switch of a switch fabric.

14. The system of claim 8, wherein the destination node is configured to:
receive the two or more flits of the super flit;
decrypt the two or more requests embedded in the received two or more flits;
regenerate the message authentication code based on the decrypted two or more requests;
extract the message authentication code appended to the last flit of the super flit;
compare the extracted message authentication code and the regenerated message authentication code; and
verify the decrypted two or more requests based on a result of the comparison.

15. A computer-implemented method comprising:
generating, by at least one processor, a super flit containing two or more flits having two or more requests embedded therein, wherein the two or more requests have destination node identifiers that are the same and the super flit has a variable size based on a flit size and a number of existing requests in a source node that target a same destination node;
appending, by the at least one processor, a message authentication code to a last flit of the super flit; and
sending, by the at least one processor, the super flit to a network switch configured to route the super flit to a destination node corresponding to the same destination node identifiers.

16. The computer-implemented method of claim 15, wherein generating the super flit includes:
extracting requests that have the same destination node identifiers;
selecting, from the extracted requests, the two or more requests, wherein the two or more requests have a total size less than N*L−M bytes, where N is a number of flits in the super flit, L is the flit size, and M is a message authentication code size;
encrypting the two or more requests; and
embedding the encrypted two or more requests in N flits of the super flit.

17. The method of claim 16, wherein the requests are extracted from a request list.

18. The method of claim 16, wherein the two or more requests are encrypted utilizing a counter mode encryption engine.

19. The method of claim 15, further comprising generating the message authentication code based on the two or more requests.

20. The method of claim 15, wherein the network switch corresponds to a network switch of a switch fabric.
